(19) United States
(12) Patent Application Publication
(10) Pub. No.: US 2008/0115812 A1
(43) Pub. Date: May 22, 2008

(54) Device for Supporting and Cleaning a Felt in a Paper Production Plant

(76) Inventors: Klaus Bartelmuss, Teufenbach (AT); Heinz Bartelmuss, Teufenbach (AT)

Correspondence Address: LERNER GREENBERG STEMER LLP, P O BOX 2480, HOLLYWOOD, FL, 33022-2480, US

(21) Appl. No.: 11/943,866

(22) Filed: Nov. 21, 2007

(30) Foreign Application Priority Data
Nov. 21, 2006 (AT) A 1924/2006
Mar. 30, 2007 (AT) A 504/2007

(51) Int. Cl. B08B 3/02

(52) U.S. Cl. 134/122 R

(57) ABSTRACT

In a device for cleaning a felt in a paper production plant, the felt is guided over supporting elements and the supporting elements are assigned at least one suction device and at least one device for applying a cleaning liquid to the felt. In this case, on both sides of the felt in each case there are provided supporting elements which extend transversely with respect to the felt. The supporting elements are disposed on the two sides of the felt offset in relation to one another in the longitudinal direction of the felt in such a way that in each case a supporting element disposed on one side is located between two supporting elements disposed on the other side of the felt and projects in between the latter, which results in that the felt is moved in a wavy course between the mutually opposite supporting elements. A suction channel is disposed between two supporting elements located beside each other.

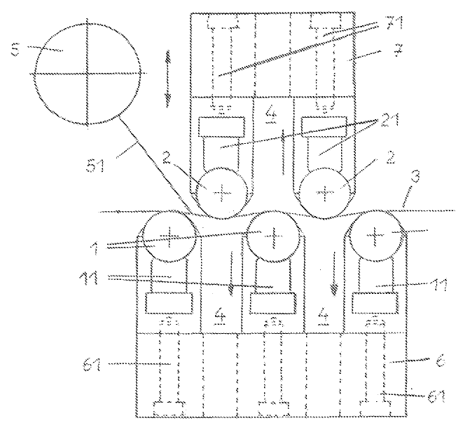

### CROSS-REFERENCE TO RELATED APPLICATION

This application claims the priority, under 35 U.S.C. § 119, of Austrian applications A 1924/2006, filed Nov. 21, 2006 and A 504/2007, filed Mar. 30, 2007; the prior applications are herewith incorporated by reference in their entirety.

### BACKGROUND OF THE INVENTION

### Field of the Invention

The invention relates to a device for supporting and cleaning a felt in a paper production plant, which is guided over supporting elements and which is assigned at least one suction device and at least one device for applying a cleaning liquid to the same.

In paper production plants, there are at least one wire and at least one felt adjoining the latter in the direction of movement, the two being moved over supporting elements in the plants at speeds of about 30 m/sec. At the start of its movement path, a paper stock is sprayed onto the wire. Along the movement path of the wire, the liquid contained in the paper stock is led away through the wire, in particular sucked away. The paper web produced as a result is then transferred to the felt, on which it is dried. The paper web is then detached from the felt and processed further, in particular dried further and rolled.

Since contaminants, such as fiber components, fillers and the like, get into the felts, as a result of which the action of the felt is impaired, there is the need to clean the latter in the course of its movement path. The cleaning is carried out by a spray pipe disposed transversely with respect to the movement path and at least one suction device being provided, a cleaning liquid being applied to the felt by a spray pipe and the cleaning liquid containing the contaminants being sucked away by the at least one suction device. As a rule, the spray pipe and the suction device are disposed on the same side of the felt.

However, since the felt is formed of a dense woven fabric, there are difficulties in removing the contaminants located therein.

### BRIEF SUMMARY OF THE INVENTION

It is accordingly an object of the invention to provide a device for supporting and cleaning a felt in a paper production plant which overcomes the above-mentioned disadvantages of the prior art devices of this general type.

With the foregoing and other objects in view there is provided, in accordance with the invention, a device for cleaning a felt in a paper production plant. The device contains supporting elements disposed on both sides of the felt for guiding the felt. The supporting elements extend transversely with respect to the felt. The supporting elements disposed on the two sides of the felt are offset in relation to one another in a longitudinal direction of the felt such that in each case a respective supporting element disposed on one side is located between two of the supporting elements disposed on the other side of the felt and the respective supporting element projects in between the two supporting elements on the other side. This results in the felt being moved in a wavy course between mutually opposite ones of the supporting elements. A suction channel is disposed between two of the supporting elements arranged beside each other. At least one device is provided for applying a cleaning liquid to the felt.

The present invention is thus based on the object of providing a device by which more effective cleaning of felts, as compared with known devices, is made possible. According to the invention, the object is achieved in that, on both sides of the felt, in each case there are provided supporting elements which extend transversely with respect to the felt, the supporting elements disposed on the two sides of the felt being offset in relation to one another in the longitudinal direction of the felt in such a way that in each case a supporting element disposed on one side is located between two supporting elements disposed on the other side of the felt and projects in between the latter, which results in that the felt is moved into a wavy course between the mutually opposite supporting elements, and that there is at least one suction channel disposed between two supporting elements located beside each other.

Preferably, individual supporting elements or all the supporting elements on one side of the felt can be adjusted in terms of their distance with respect to the supporting elements on the other side of the felt. In addition, in each case at least one suction channel can be located between the supporting elements on the two sides of the felt.

According to a configuration variant, there is at least one suction channel on one side of the felt and at least one pressure channel for air, for a cleaning liquid or for a mixture of these two media on the other side of the felt.

According to a preferred embodiment, the supporting elements in each case located on one side of the felt are disposed on a common carrier. In this case, the supporting elements can be formed in particular by supporting rollers which are mounted in bearing shells to which a medium capable of flowing, such as water or air, can be supplied, by which means they are kept at a distance from the bearing surface.

Other features which are considered as characteristic for the invention are set forth in the appended claims.

Although the invention is illustrated and described herein as embodied in a device for supporting and cleaning a felt in a paper production plant, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a diagrammatic, side view of a device according to the invention.

### DETAILED DESCRIPTION OF THE INVENTION

Referring now to the single FIGURE of drawing in detail, there is shown a device that contains two groups of supporting rollers 1 and 2, which are located on the two sides of a felt 3. Furthermore, suction channels 4 connected to a suction device are provided between the supporting rollers 1 and 2. Furthermore, the supporting rollers 2 in each case located on one side of the felt 3 are offset with respect to the supporting rollers 1 provided on the other side of the felt 3 and they project into the spaces between the supporting rollers 1, which results in the felt 3 being moved in a wavy course. Preferably, the individual supporting rollers 2 can be adjusted in terms of their distance with respect to the supporting rollers 1 on the other side of the felt 3, which results in that the wavy course of the felt 3 can be varied.

In addition, a spray pipe 5 oriented transversely with respect to the movement of the felt 3 is provided, by which a cleaning liquid 51 can be applied to the felt 3. The felt 3 is cleaned by the cleaning liquid 51 being applied to the felt 3 by the spray pipe 5, picking up the contaminants in the felt 3 and subsequently being sucked away through the suction channels 4. In this way, the felt 3 is cleaned. The cleaning action is promoted by the fact that the felt 3 between the two groups of supporting rollers 1 and 2 is moved through in a wavy course. By this measure, as compared with known devices, a substantially improved effect is achieved during the cleaning of the felt 3.

In the exemplary embodiment illustrated, the supporting rollers 1 and 2 are mounted in bearing shells 11 and 21, to which a medium capable of flowing, such as water or air, is supplied, by which they are lifted off the bearing surfaces and in this way can be rotated virtually without friction. In this case, the bearing shells 11 and 21 provided on each side of the felt 3 are fixed to respectively common supports 6 and 7 by screws 61 and 71.

According to a configuration variant, at least one suction channel can be provided on one side of the felt 3 and at least one pressure channel can be provided on the other side of the felt 3. Furthermore, either air or a cleaning liquid, in particular water, or a mixture of air and a cleaning liquid can be introduced into the pressure channels. In this case, a spraying device is not required. The cleaning action is also improved in this way.

Instead of the supporting rollers, supporting strips can also be provided, between which the suction channels 4 and/or pressure channels are located. In this case, the surfaces of the supporting strips assigned to the felt 3 are preferably coated with plates made of a ceramic material.

Definitive for the device according to the invention is that the felt 3 is led through between two groups of supporting elements which are offset in relation to one another and project into the respective interspaces, by which the felt is guided in a wavy movement for its cleaning. As a result, the structure of the felt is changed continuously, which results in that the contaminants located in the latter can be removed more easily from it than is the case in previously known plants.

1. A device for cleaning a felt in a paper production plant, the device comprising:
supporting elements disposed on both sides of the felt for guiding the felt, said supporting elements extending transversely with respect to the felt, said supporting elements disposed on the two sides of the felt being offset in relation to one another in a longitudinal direction of the felt such that in each case a respective supporting element disposed on one side is located between two of said supporting elements disposed on the other side of the felt and said respective supporting element projects in between said two supporting elements on the other side, resulting in the felt being moved in a wavy course between mutually opposite ones of said supporting elements;
a suction channel disposed between two of said supporting elements disposed beside each other; and
at least one device for applying a cleaning liquid to the felt.

2. The device according to claim 1, wherein at least one of said supporting elements on one side of the felt can be adjusted in terms of a distance with respect to said supporting elements on the other side of the felt.

3. The device according to claim 1, wherein said suction channel is one of a plurality of suction channels, said suction channels are disposed between said supporting elements on both sides of the felt.

4. The device according to claim 1,
wherein said suction channel is disposed on one side of the felt; and
further comprising at least one pressure channel for one of air, a cleaning liquid, and a mixture of air and a cleaning liquid, disposed on the other side of the felt.

5. The device according to claim 1, further comprising common carriers and said supporting elements in each case disposed on one side of the felt are all disposed on one of said common carriers.

6. The device according to claim 1, wherein said supporting elements include bearing shells each having a bearing surface and supporting rollers mounted in said bearing shells to which a medium capable of flowing is supplied, by said bearing shells receiving said medium said supporting rollers are kept at a distance from said bearing surface.

7. The device according to claim 6, wherein said medium is selected from the group consisting of air and water.
